(19) United States
(12) Patent Application Publication
(10) Pub. No.: US 2026/0174114 A1
(43) Pub. Date: Jun. 25, 2026

(54) HERB COATED EDIBLE PRODUCTS

(71) Applicant: Starbucks Corporation, Seattle, WA (US)

(72) Inventor: William Altieri, Seattle, WA (US)

(21) Appl. No.: 19/425,010

(22) Filed: Dec. 18, 2025

Related U.S. Application Data
(60) Provisional application No. 63/736,599, filed on Dec. 19, 2024.

(51) Int. Cl. A23L 19/00; A23B 7/024; A23L 2/39; A23L 2/52; A23L 27/10; A23L 29/00

(52) U.S. Cl. CPC A23L 19/05; A23B 7/024; A23L 2/39; A23L 2/52; A23L 27/10; A23L 29/04

(57) ABSTRACT

The disclosure relates to edible products made up of a dehydrated food product (e.g., a freeze-dried food product such as, for example, a fruit, a vegetable, or a seed) having thereon a substantially uniform coating of an oil and an herb powder. Also disclosed are compositions comprising a plurality of the edible products and beverages containing edible products. Methods of making and using same are also disclosed. This abstract is intended as a scanning tool for purposes of searching in the particular art and is not intended to be limiting of the present disclosure.

### CROSS-REFERENCE TO RELATED APPLICATIONS

This application claims the benefit of U.S. Application No. 63/736,599, filed on Dec. 19, 2024, the contents of which are incorporated herein by reference in its entirety.

### BACKGROUND

Food dehydration refers to method of food preservation by which moisture levels in the food are sufficiently reduced such that microorganisms including molds, yeast, and bacteria cannot grow and spoil the food. Typically, heat is added to the food (e.g., via the sun, an oven, a microwave, or an electric dehydrator), although cold temperatures can also be utilized (e.g., freeze drying techniques). Food dehydration can be applied to a wide range of different foods, including fruits (e.g., bananas, cherries, apples, aggregate fruits, grapes, figs, peaches, oranges, pears, cantaloupe), vegetables (e.g., carrots, corn, asparagus, broccoli, mushrooms, onions, peas), herbs, grains (e.g., rice, barley), nuts, seeds, pet food, yogurts, and even meats and fish (e.g., ground beef, chicken, turkey, beef jerky, fresh fish, cured meats).

One concern related to the dehydration process is the loss of the nutritional value of the food. For example, vitamins A and C can be destroyed by heat. The use of cold temperatures, therefore, presents as an attractive alternative. Unlike other dehydrated foods, freeze-dried foods retain the vast majority of the vitamins and minerals found in their original state. Freeze-dried foods also tend to weigh less than foods dehydrated by alternative means, and also retain more of their original visual appearance and taste.

Dehydrated foods, including freeze-dried foods, have been used in a variety of different food and beverage products, including soups, smoothies, yogurts, salads, waters, teas, and fruit juices, among others. If additional flavors are desired (e.g., herb flavors, other seasonings), a flavorant can be added to the product as a separate component. Unfortunately, flavorants can often be overpowering, and, in the case of herb flavorants, result in an artificial and unsavory taste. An alternative strategy would be to pre-mix the herb and the dehydrated food in order to produce a single ingredient that could then be added to the food or beverage product or enjoyed directly by the consumer as is. However, dehydrated foods tend to be very brittle and mixing them without breakage is a continuing concern. Further, as herbs can also be dehydrated, it can be difficult to combine the two components in a form that allows them to be unified into a single product. Additional concerns include facilitating attachment of the herb onto the food, forming an even and consistent coating, and avoiding clumping of the herb on the equipment. Thus, there remains a need for edible products that contain both a dehydrated food product and one or more herbs in combination. These needs and others are met by the present invention.

### SUMMARY

In accordance with the purpose(s) of the invention, as embodied and broadly described herein, the invention, in one aspect, relates to edible products made up of a dehydrated food product (e.g., a freeze-dried food product such as, for example, a fruit, a vegetable, or a seed) having thereon a substantially uniform coating of an oil and an herb powder. Also disclosed are compositions comprising a plurality of the edible products and beverages containing edible products. Methods of making and using same are also disclosed.

Thus, disclosed are edible products comprising a dehydrated food product, at least a portion of which is coated with a mixture comprising an oil and an herb powder.

Also disclosed are compositions comprising a plurality of the disclosed edible products, wherein the herb powder is present in the composition in an amount of from about 0.60 wt % to about 1.0 wt %, and wherein the edible oil and the herb powder are present in a ratio of from about 3:2 to about 7:2.

Also disclosed are beverages comprising a disclosed edible product or a disclosed composition.

Also disclosed are kits comprising a disclosed edible product or a disclosed composition, and one or more selected from: (a) a food; (b) a beverage or beverage component; (c) instructions for preparing a food or a beverage; and (d) instructions for adding an edible product to a food or a beverage or beverage component.

Also disclosed are methods of making a disclosed edible product, the method comprising: (a) providing a dehydrated food product; (b) dispensing an oil onto the dehydrated food product; (c) dispensing an herb powder onto the dehydrated food product; and (d) blending the oil, the herb powder, and the dehydrated food product using a flat tumbler system.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1A and FIG. 1B show alternative representative flow diagrams of processes for making edible products as disclosed herein. Specifically, FIG. 1A shows a representative flow diagram of a process for making a freeze-dried food product. FIG. 1B shows a representative flow diagram of a process for making an edible product coated with an oil and an herb powder.

FIG. 2A and FIG. 2B show representative images of an exemplary edible product (i.e., freeze-dried blackberries coated with coconut oil and sage powder) prepared using methods as disclosed herein.

FIG. 3A and FIG. 3B show representative images of comparative freeze-dried blackberries coated with coconut oil and sage powder, which berries have been overworked and prepared using an alternative method to that disclosed here. As shown, the product displays excessive broken pieces, corn cobbing, and fines.

FIG. 4 shows a representative image of comparative freeze-dried blackberries coated with coconut oil and sage powder that have been overworked and prepared using an alternative method to that disclosed here. As shown, the berry drupelets have been broken off and the red interior of the berry is exposed.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present edible products, compositions, and/or beverages are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Disclosed are the components to be used to prepare the edible products, compositions, and/or beverages of the invention as well as the edible products, compositions, and/or beverages themselves to be used within the methods disclosed herein. These and other materials are disclosed herein, and it is understood that when combinations, subsets, interactions, groups, etc. of these materials are disclosed that while specific reference of each various individual and collective combinations and permutation of these edible products, compositions, and/or beverages cannot be explicitly disclosed, each is specifically contemplated and described herein. For example, if a particular edible product is disclosed and discussed and a number of modifications that can be made to a number of materials including the edible products are discussed, specifically contemplated is each and every combination and permutation of the edible product and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including steps in methods of making and using the edible products and compositions of the invention. Thus, if there are a variety of additional steps that can be performed it is understood that each of these additional steps can be performed with any specific embodiment or combination of embodiments of the methods of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. Definitions

As used in the specification and the appended claims, the singular forms “a,” “an” and “the” include plural referents unless the context clearly dictates otherwise. Thus, for example, reference to “an edible product,” “a composition,” or “a beverage” includes mixtures of two or more such edible products, compositions, beverages, and the like.

References to an edible product, a composition, or a beverage containing “an” ingredient is intended to include other ingredients, respectively, in addition to the one named.

By “comprising” or “containing” or “having” it is intended that at least the named component, element, material, or method step, etc., is present in the edible product, composition, or beverage, but does not exclude the presence of other components, elements, materials, method steps, etc., even if the other such components, elements, materials, method steps, etc., have the same function as what is named, unless expressly excluded in the claims.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

As used herein, the term “food product” refers to an edible ingredient. Examples of edible ingredients include, but are not limited to, fruits (e.g., bananas, cherries, apples, aggregate fruits, grapes, figs, peaches, oranges, pears, cantaloupe), vegetables (e.g., carrots, corn, asparagus, broccoli, mushrooms, onions, peas), herbs, grains (e.g., rice, barley), nuts, seeds, pet food, yogurts, and even meats and fish (e.g., ground beef, chicken, turkey, beef jerky, fresh fish, cured meats).

As used herein, the term “uniformly” means in a manner that is consistent such that it does not appear to vary and/or appears to be the same throughout. In various aspects, a disclosed food component is coated uniformly or substantially uniformly with a mixture (e.g., a mixture of an oil and an herb powder) such that the surface of the food component appears to have an even coating of the mixture throughout. In various aspects, a disclosed food component is coated relatively uniformly with a mixture such that the coating on the surface of the food component appears to be more uniform than the same coating on the surface of a food component in which the coating was applied using a different method (e.g., a method different than the method disclosed herein).

### B. Edible Products

In one aspect, disclosed are edible products comprising a dehydrated food product, at least a portion of which is coated with a mixture comprising an oil and an herb powder. As used herein, the term “edible product,” means a product that contains at least two different edible ingredients that have been combined (e.g., bound together) to form a single product. For example, as disclosed herein, an edible product can contain a dehydrated food product (e.g., a dehydrated aggregate fruit) and an herb (e.g., an herb powder) that are bound together by a third edible ingredient (e.g., an oil).

The disclosed edible products beneficially combine a dehydrated food product (e.g., a dehydrated fruit, a dehydrated vegetable, or a dehydrated seed) and an herb into a single ingredient that can be eaten individually (as a snack) or, alternatively, that can be added directly to a food or a beverage, without the need to add herbal flavorants or seasonings separately. In addition, the disclosed edible products achieve a pleasing, herbaceous, and savory taste, which is often lost and/or overpowered when flavorants are used. The disclosed edible products are also visually appealing, generally maintaining the original shape and color of the food product before dehydration, with minimal or no breakage and crumbling. Additional advantages of the disclosed edible product include limiting the number of ingredients needed, minimizing storage space, and reducing ingredient spend.

In various aspects, the ratio of the oil to the herb powder can be selected to maximize adherence of the herb powder onto the aggregate fruit and also to minimize the amount of the herb powder that accumulates on the equipment. Thus, in various aspects, the oil and the herb powder are present in the edible product in a ratio of from about 3:2 to about 7:2. In various further aspects, the oil and the herb powder are present in the edible product in a ratio of from about 3:2 to about 3:1, from about 3:2 to about 5:2, from about 3:2 to about 1:2, from about 1:2 to about 7:2, from about 5:2 to about 7:2, from about 3:1 to about 7:2, or from about 1:2 to about 3:1. In a still further aspect, the oil and the herb powder are present in the edible product in a ratio of about 3:2, about 3:1, about 5:2, about 1:2, or about 7:2. In a yet further aspect, the oil and the herb powder are present in the edible product in a ratio of about 5:2.

In various aspects, the edible product comprises a freeze-dried food product, at least a portion of which is coated with a mixture comprising: (a) an edible oil selected from avocado oil, coconut oil, safflower oil, olive oil, sunflower oil, flax oil, palm oil, soybean oil, canola oil, corn oil, and peanut oil, or a mixture thereof; and (b) an herb powder selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof, and wherein the oil and the herb powder are present in the composition in a ratio of from about 3:2 to about 7:2. In a further aspect, the freeze-dried food product is a freeze-dried fruit. In a still further aspect, the freeze-dried fruit is a freeze-dried aggregate fruit. In yet a further aspect, the freeze-dried aggregate fruit is a freeze-dried blackberry. In an even further aspect, the oil is a coconut oil. In a still further aspect, the herb powder is a sage powder.

In various aspects, the edible product comprises a freeze-dried aggregate fruit, at least a portion of which is coated with a mixture comprising: (a) coconut oil; and (b) an herb powder selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof, and wherein the coconut oil and the herb powder are present in the composition in a ratio of from about 3:2 to about 7:2. In a further aspect, the freeze-dried food product is a freeze-dried fruit. In a still further aspect, the freeze-dried fruit is a freeze-dried aggregate fruit. In yet a further aspect, the freeze-dried berry is a freeze-dried blackberry. In an even further aspect, the oil is a coconut oil. In a still further aspect, the herb powder is a sage powder.

### 1. Dehydrated Food Products

In one aspect, the disclosed edible products comprise a dehydrated food product. As used herein, the term “dehydrated food product” means a food product having a total moisture content of less than about 5 wt %. Thus, in various aspects, a dehydrated food product can have a total moisture content of less than about 5 wt %, less than about 4 wt %, less than about 3 wt %, less than about 2 wt %, or less than about 1 wt %.

Methods of preparing dehydrated food products are well-known in the art and include, but are not limited to, oven drying, an electric dehydrator, microwave drying, air drying, sun drying, and freeze-drying. As would be understood by one of skill in the art, preparation methods require that the moisture content of the food product is reduced compared to the moisture content of the food product before dehydration, as further detailed herein.

A variety of different food products can be dehydrated including, but not limited to, fruits (e.g., bananas, cherries, apples, aggregate fruits, grapes, figs, peaches, oranges, pears, cantaloupe), vegetables (e.g., carrots, corn, asparagus, broccoli, mushrooms, onions, peas), herbs, grains (e.g., rice, barley), nuts, seeds, pet food, yogurts, and even meats and fish (e.g., ground beef, chicken, turkey, beef jerky, fresh fish, cured meats). Thus, in various aspects, the dehydrated food product is a dehydrated fruit, a dehydrated vegetable, or a dehydrated seed.

In various aspects, the dehydrated food product is a dehydrated fruit. Examples of fruits that can be dehydrated include, but are not limited to, bananas, cherries, apples, aggregate fruits, grapes, figs, peaches, oranges, pears, cantaloupe, tomatoes, and pineapple. In a further aspect, the dehydrated fruit is a dehydrated berry such as, for example, a dehydrated strawberry, a dehydrated blueberry, a dehydrated raspberry, a dehydrated blackberry, and a dehydrated cranberry. In a further aspect, the dehydrated fruit is a dehydrated aggregate fruit. In a still further aspect, the dehydrated aggregate fruit is a dehydrated blackberry.

In various aspects, the dehydrated food product is a dehydrated vegetable. Examples of vegetables that can be dehydrated include, but are not limited to, carrots, corn, cabbage, green beans, spinach, squash, celery, potatoes, sweet potatoes, kale, asparagus, broccoli, mushrooms, onions, and peas.

In various aspects, the dehydrated food product is a dehydrated seed. Examples of seeds that can be dehydrated include, but are not limited to, chia seeds, pumpkin seeds, sunflower seeds, and hemp seeds.

In various aspects, the dehydrated food product is a freeze-dried food product. As used herein, the term “freeze-dried food product” means a dehydrated food product that has been dehydrated via rapid freezing at a very low temperature (e.g., between −30° F. and −50° F.), followed by treatment in a high vacuum (e.g., a pressure of about 0.01 mbar). Thus, in various aspects, the freeze-dried food product has been prepared by rapid freezing at a temperature of from about −30° F. to about −50° F., from about −30° F. to about −45° F., from about −30° F. to about −40° F., from about −30° F. to about −35° F., from about −35° F. to about-50° F., from about −40° F. to about −50° F., from about −45° F. to about −50° F., or from about-35° F. to about −45° F., followed by treatment in a high vacuum.

A variety of different food products can be freeze-dried including, but not limited to, fruits (e.g., bananas, cherries, apples, berries, including aggregate fruits, grapes, figs, peaches, oranges, pears, cantaloupe), vegetables (e.g., carrots, corn, asparagus, broccoli, mushrooms, onions, peas), herbs, grains (e.g., rice, barley), nuts, seeds, pet food, yogurts, and even meats and fish (e.g., ground beef, chicken, turkey, beef jerky, fresh fish, cured meats). Thus, in various aspects, the freeze-dried food product is a freeze-dried fruit, a freeze-dried vegetable, or a freeze-dried seed.

In various aspects, the freeze-dried food product is a freeze-dried fruit. Examples of fruits that can be freeze-dried include, but are not limited to, bananas, cherries, apples, aggregate fruits, berries, grapes, figs, peaches, oranges, pears, cantaloupe, tomatoes, and pineapple. In a further aspect, the freeze-dried fruit is a freeze-dried berry such as, for example, a freeze-dried strawberry, a freeze-dried blueberry, a freeze-dried raspberry, a freeze-dried blackberry, and a freeze-dried cranberry. In a yet further aspect, the freeze-dried fruit is an aggregate fruit. In a still further aspect, the freeze-dried aggregate fruit is a freeze-dried blackberry.

In various aspects, the freeze-dried food product is a freeze-dried vegetable. Examples of vegetables that can be freeze-dried include, but are not limited to, carrots, corn, cabbage, green beans, spinach, squash, celery, potatoes, sweet potatoes, kale, asparagus, broccoli, mushrooms, onions, and peas.

In various aspects, the freeze-dried food product is a freeze-dried seed. Examples of seeds that can be freeze-dried include, but are not limited to, chia seeds, pumpkin seeds, sunflower seeds, and hemp seeds.

In various aspects, the dehydrated fruit is uniformly coated with the mixture. In a still further aspect, the dehydrated fruit is coated substantially uniformly with the mixture. In yet a further aspect, the dehydrated fruit is coated relatively uniformly with the mixture.

### 2. Oils

In one aspect, the disclosed dehydrated food product is coated with one or more oils. As used herein, the term “oil” refers to a lipid material that is generally soluble in organic solvents but insoluble in water. Unlike fats, which are solid at room temperature, oils remain liquid at room temperature. Oils can be derived from animal, vegetable, or synthetic sources. One type of oil (e.g., oil derived from a single source) can be used alone, or, alternatively, a plurality of two or more types of oils (e.g., oils derived from two or more different sources) can be combined into a single oil for use herein. Examples of oils include, but are not limited to, avocado oil, coconut oil, safflower oil, olive oil, sunflower oil, flax oil, palm oil, soybean oil, canola oil, corn oil, and peanut oil.

As detailed herein, an oil can be used to adhere the herb powder onto the dehydrated food product. The amount of oil used must be significant enough to ensure that the dehydrated food product is sufficiently coated with the herb powder. However, if too much oil is used, it can pool off of the dehydrated food product. This can be particularly problematic when the edible product is used in a beverage. Thus, in various aspects, the oil is present in the edible product in an amount of from about 0.50 wt % to about 10 wt %. In various further aspects, the oil is present in the edible product in an amount of from about 0.50 wt % to about 8 wt %, from about 0.50 wt % to about 6 wt %, from about 0.50 wt % to about 4 wt %, from about 0.50 wt % to about 2 wt %, from about 2 wt % to about 10 wt %, from about 4 wt % to about 10 wt %, from about 6 wt % to about 10 wt %, from about 8 wt % to about 10 wt %, from about 2 wt % to about 8 wt %, or from about 4 wt % to about 6 wt %. In a further aspect, the oil is present in the edible product in an amount of from about 2.0 wt % to about 6.0 wt %. In a still further aspect, the oil is present in the edible product in an amount of about 0.5 wt %, about 1.0 wt %, about 2.0 wt %, about 3.0 wt %, about 4.0 wt %, about 5.0 wt %, about 6.0 wt %, about 7.0 wt %, about 8.0 wt %, about 9.0 wt %, or about 10 wt %. In yet a further aspect, the oil is present in the edible product in an amount of about 4.0 wt %.

The ratio of the oil to the herb powder is also significant in achieving the beneficial properties of the disclosed edible products. For example, if the ratio of the oil to the herb powder is too low, the herb powder will not adhere sufficiently to the dehydrated food product. In contrast, if the ratio of the oil to the herb powder is too high, the herb powder can accumulate on the equipment used to prepare the edible product. Acceptable ratio of the oil to the herb powder are detailed elsewhere herein.

In various aspects, the oil is an edible oil.

In various aspects, the oil is selected from avocado oil, coconut oil, safflower oil, olive oil, sunflower oil, flax oil, palm oil, soybean oil, canola oil, corn oil, and peanut oil, or a mixture thereof. In a further aspect, the oil is one of avocado oil, coconut oil, safflower oil, olive oil, sunflower oil, flax oil, palm oil, soybean oil, canola oil, corn oil, and peanut oil. In a still further aspect, the oil is a mixture of two or more of avocado oil, coconut oil, safflower oil, olive oil, sunflower oil, flax oil, palm oil, soybean oil, canola oil, corn oil, and peanut oil. In yet a further aspect, the oil is a coconut oil.

### 3. Herb Powders

In one aspect, the disclosed dehydrated food product is coated with one or more oils. As used herein, the term” herb” refers to a plant having leaves, seeds, bark, roots, flowers, or other components that are edible and used for flavoring, food, or medicine. The term “herb powder,” as used herein, refers to a powder that has been formed via drying an herb (e.g., the leaves, seeds or flowers of the herb) and finely grinding, crushing, and/or disintegrating the dried herb to a finely divided, particulate state. Examples of herb powders are known in the art, and include, but are not limited to, dill powder, sage powder, thyme powder, basil powder, cinnamon powder, paprika powder, garlic powder, onion powder, rosemary powder, pumpkin spice powder, apple pie spice powder, marijuana powder, and chili powder. Additional examples of herbs that can be formed into an herb powder include, but are not limited, Ginkgo biloba, rooibos, mint, chamomile, st. hawthornberry, gotsukora, mate, rosehip, hibiscus, ashwagandha, borage, oats, sage, yarrow, marsh mallow, yellow dock root, dandelion, anise seed, marigold, caraway, turmeric, milk thistle, artichoke, olive leaf, chest tree, nettle, valerian, ladies mantle, marjoram, echinacea, fennel, angelica, ginger, and cinnamon.

Methods of making herb powders are well-known in the art. For example, an herb can be separated into its component parts, whereby one or more parts are used to prepare the powder, or can be used in whole form. The herb (or herb part) is then thoroughly dried before being ground (e.g., via mortar and pestle) and passed through a sieve (e.g., a mesh) having sufficiently small size (e.g., about 40 mesh). The resultant powder can be subject to further straining until the size and consistency of the resultant powder is acceptable.

The herb powder can be used in raw form (i.e., a raw herb powder), as a coarsely ground powder, or as finely ground powder. One type of herb can be used alone, or, alternatively, a plurality of two or more types of herbs can be combined into a powder form.

In various aspects, the amount of herb powder used can be selected relative to the amount of oil and/or the amount of dehydrated food product present in the edible product. Thus, for example, in various aspects, the herb powder is present in the edible product in an amount of from about 0.40 wt % to about 1.4 wt %. Thus, in various aspects, the herb powder is present in the edible product in an amount of from about 0.40 wt % to about 1.2 wt %, from about 0.40 wt % to about 1.0 wt %, from about 0.40 wt % to about 0.80 wt %, from about 0.40 wt % to about 0.60 wt %, from about 0.60 wt % to about 1.4 wt %, from about 0.80 wt % to about 1.4 wt %, from about 1.0 wt % to about 1.4 wt %, from about 1.2 wt % to about 1.4 wt %, from about 0.60 wt % to about 1.2 wt %, or from about 0.80 wt % to about 1.0 wt %. In a further aspect, the herb powder is present in the edible product in an amount of from about 0.60 wt % to about 1.0 wt %. In a still further aspect, the herb powder is present in the edible product in an amount of about 0.40 wt %, about 0.60 wt %, about 0.80 wt %, about 1.0 wt %, about 1.2 wt %, or about 1.4 wt %. In yet a further aspect, the herb powder is present in the in an amount of about 0.80 wt %.

In various aspects, the herb powder is selected from a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder, or a mixture thereof. In a further aspect, the herb powder is one of a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder. In a still further aspect, the herb powder is a mixture of two or more of a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder.

In various aspects, the herb powder is selected from a dill powder, a sage powder, a thyme powder, a basil powder, a cinnamon powder, a paprika powder, a garlic powder, an onion powder, a rosemary powder, a pumpkin spice powder, an apple pie spice powder, and a chili powder, or a mixture thereof. In a still further aspect, the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In yet a further aspect, the herb powder is selected from a dill powder, a sage powder, a thyme powder, a basil powder, a cinnamon powder, a paprika powder, a garlic powder, an onion powder, a rosemary powder, a pumpkin spice powder, and an apple pie spice powder, or a mixture thereof. In an even further aspect, herb powder is a sage powder.

### 4. Properties

As detailed further herein, the disclosed edible products can have various properties, including low moisture content and low water activity. It is also understood that the disclosed edible products have other properties.

As used herein, the term “moisture content” means the volume of water or water vapor found within a substance, e.g., a disclosed edible product. Moisture content is usually expressed as a percentage of weight. Thus, in various aspects, a disclosed edible product can have a moisture content of less than about 4 wt %, less than about 3.5 wt %, less than about 3 wt %, less than about 2.5 wt %, less than about 2 wt %, less than about 1.5 wt %, less than about 1 wt %, or less than about 0.5 wt %. In various further aspects, a disclosed edible product has a moisture content that is at least 0.1 wt % less than a comparative edible product prepared by a different method than those disclosed herein. Thus, in various further aspects, a disclosed edible product has a moisture content that is at least 0.2 wt % less, at least 0.3 wt % less, at least 0.4 wt % less, at least 0.5 wt % less, at least 0.6 wt % less, at least 0.7 wt % less, at least 0.8 wt % less, at least 0.9 wt % less, or at least 1.0 wt % less than a comparative edible product prepared by a different method than those disclosed herein.

The term “water activity” (aw), as used in relation to the edible products and compositions disclosed herein, means the ratio of the vapor pressure of the edible product, when in a completely undisturbed balance with the surrounding air media, and the vapor pressure of distilled water under identical conditions. Thus, a water activity of 0.80 means that the vapor pressure is 80 percent of that of pure water. As would be appreciated by one of ordinary skill in the art, the water activity of a food product can provide information on storage life, agglomeration or pourability, and cohesion. In various aspects, a disclosed edible product has a water activity of about 0.3 or less, about 0.25 or less, about 0.2 or less, about 0.15 or less, or about 0.1 or less. In various further aspects, a disclosed edible product has a water activity that is at least 0.1 wt % less than a comparative edible product prepared by a different method than those disclosed herein. Thus, in various further aspects, a disclosed edible product has a water activity that is at least 0.2 wt % less, at least 0.3 wt % less, at least 0.4 wt % less, at least 0.5 wt % less, at least 0.6 wt % less, at least 0.7 wt % less, at least 0.8 wt % less, at least 0.9 wt % less, or at least 1.0 wt % less than a comparative edible product prepared by a different method than those disclosed herein.

### C. Methods of Making an Edible Product

In one aspect, disclosed are methods of making a disclosed edible product, the method comprising: (a) providing a dehydrated food product; (b) dispensing an oil onto the dehydrated food product; (c) dispensing an herb powder onto the dehydrated food product; and (d) blending the oil, the herb powder, and the dehydrated food product using a flat tumbler system.

In various aspects, the dehydrated food product is a dehydrated fruit, a dehydrated vegetable, or a dehydrated seed. In a further aspect, the dehydrated food product is a dehydrated fruit (e.g., a dehydrated berry such as, for example, a dehydrated strawberry, a dehydrated blueberry, a dehydrated raspberry, a dehydrated blackberry, a dehydrated cranberry). In a yet further aspect, the dehydrated fruit is a dehydrated aggregate fruit. In a still further aspect, the dehydrated aggregate fruit is a dehydrated blackberry. In various further aspects, the dehydrated food product is a dehydrated vegetable. In various further aspects, the dehydrated food product is a dehydrated seed.

In various aspects, the dehydrated food product is a freeze-dried food product such as, for example, a freeze-dried fruit, a freeze-dried vegetable, or a freeze-dried seed. In a further aspect, the freeze-dried food product is a freeze-dried berry (e.g., a freeze-dried strawberry, a freeze-dried blueberry, a freeze-dried raspberry, a freeze-dried blackberry, a freeze-dried cranberry).

Thus, in various aspects, the method further comprises dehydrating a food product using, for example, an oven, an electric dehydrator, a microwave, or a freeze-dryer. In various further aspects, the method further comprises preparing a freeze-dried food product.

In various aspects, providing the dehydrated food product comprises: (a) providing a food product; and (b) dehydrating the food product. In a still further aspect, dehydrating the food product is via oven drying, electric drying, microwave drying, or freeze-drying.

In various aspects, providing the dehydrated food product comprises: (a) providing a plurality of quick frozen food products; and (b) blast freezing the quick frozen food products.

In various aspects, providing the dehydrated food product comprises: (a) providing a plurality of quick frozen food products; and (b) freeze drying the quick frozen food products.

In various aspects, providing the dehydrated food product comprises: (a) providing a plurality of quick frozen food products; (b) forming an individual layer of the quick frozen food products on a tray; and (c) freeze drying the individual layer.

In various aspects, the dehydrated food product is a freeze-dried aggregate fruit, and providing the dehydrated food product comprises: (a) providing a plurality of quick frozen aggregate fruits; (b) breaking the plurality of quick frozen aggregate fruits apart and laying the quick frozen aggregate fruits flat on a tray in an individual layer; and (c) blast freezing the individual layer of quick frozen aggregate fruits, thereby providing a plurality of freeze-dried aggregate fruits.

In various aspects, the dehydrated food product is a freeze-dried aggregate fruit, and providing the dehydrated food product comprises: (a) providing a plurality of quick frozen aggregate fruits; (b) breaking the plurality of quick frozen aggregate fruits apart and laying the quick frozen aggregate fruits flat on a tray in an individual layer; and (c) freeze drying the individual layer of quick frozen aggregate fruits, thereby providing a plurality of freeze-dried aggregate fruits.

In various aspects, providing the dehydrated food product comprises: (a) providing a plurality of quick frozen aggregate fruits; (b) breaking the plurality of quick frozen aggregate fruits apart and laying the quick frozen berries flat on a tray in an individual layer; (c) blast freezing the individual layer of quick frozen aggregate fruits; and (d) freeze drying the individual layer of quick frozen aggregate fruits, thereby providing a plurality of freeze-dried aggregate fruits. In various aspects, the method further comprises breaking the plurality of freeze-dried aggregate fruits apart.

In various aspects, the oil and the herb powder are dispensed onto the dehydrated food product in different steps. Thus, in various aspects, the oil is dispensed onto the dehydrated food product before the herb powder is dispensed. In various further aspects, the herb powder is dispensed onto the dehydrated food product before the oil is dispensed. In various further aspects, the oil and the herb powder are dispensed sequentially onto the dehydrated food product. In various further aspects, the oil and the herb powder are dispensed simultaneously onto the dehydrated food product.

In various aspects, the oil is dispensed onto the dehydrated food product via spraying in, for example, a fan-like motion.

In various aspects, the oil is an edible oil. In a further aspect, the oil is selected from avocado oil, coconut oil, safflower oil, olive oil, sunflower oil, flax oil, palm oil, soybean oil, canola oil, corn oil, and peanut oil, or a mixture thereof. In a still further aspect, the oil is one of avocado oil, coconut oil, safflower oil, olive oil, sunflower oil, flax oil, palm oil, soybean oil, canola oil, corn oil, and peanut oil. In yet a further aspect, the oil is a mixture of two or more of avocado oil, coconut oil, safflower oil, olive oil, sunflower oil, flax oil, palm oil, soybean oil, canola oil, corn oil, and peanut oil. In an even further aspect, the oil is a coconut oil.

In various aspects, the herb powder is selected from a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder, or a mixture thereof. In a further aspect, the herb powder is one of a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder. In a still further aspect, the herb powder is a mixture of two or more of a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder.

In various aspects, the oil, the herb powder, and the dehydrated food product are blended together using a tumbler system, and, in particular, using a flat tumbler system. The tumbler system used should not be a paddle blender, a ribbon blender, or some other blender system in which in the interior of the blender is jagged, uneven, or has screws or screw-like components therein. Rather, the tumbler system should include a flat surface or a substantially flat surface on the interior to minimize breakage of the dehydrated food product.

In various aspects, the oil is dispensed onto the dehydrated food product while blending. In various further aspects, the herb powder is dispensed onto the dehydrated food product while blending.

In various aspects, blending comprises mixing the oil, the herb powder, and the dehydrated food product after one or both of the dispensing steps. In various further aspects, blending comprises mixing the oil, the herb powder, and the dehydrated food product after each of the dispensing steps. In various further aspects, blending comprises coating the exterior surface of the dehydrated food product with a mixture of the oil and the herb powder.

In various aspects, blending is with high shear. In various further aspects, blending is low shear.

### D. Compositions

In one aspect, disclosed are compositions comprising a plurality of the disclosed edible products. In various aspects, the edible product comprises a dehydrated food product, at least a portion of which is coated with a mixture comprising an oil and an herb powder.

In various aspects, each of the edible products in the composition comprises the same dehydrated food product. In various further aspects, edible products in the composition comprise different dehydrated food products. Thus, in various aspects, the disclosed composition can contain a plurality of edible products, each edible product comprising the same dehydrated food product (e.g., a freeze-dried blackberry). Alternatively, in various aspects, the disclosed composition can contain a plurality of edible products comprising different dehydrated food products (e.g., a freeze-dried blackberry, a freeze-dried raspberry, and a freeze-dried blueberry).

As detailed herein, the disclosed compositions can be eaten directly (e.g., as a snack), or, alternatively can be combined with a food (e.g., a soup, a salad, a yogurt, a granola, a parfait) or a beverage (e.g., a water, a fruit juice, a spritzer, a smoothie, a coffee, a tea). Further, the disclosed compositions can be pre-mixed with the food or the beverage or can be mixed just prior to consumption.

In various aspects, the plurality of the edible products are present in the composition in an amount of from about 90 wt % to about 99 wt %. Thus, in various aspects, the plurality of the edible products are present in the composition in an amount of from about 90 wt % to about 98 wt %, from about 90 wt % to about 96 wt %, from about 90 wt % to about 94 wt %, from about 90 wt % to about 92 wt %, from about 92 wt % to about 99 wt %, from about 94 wt % to about 99 wt %, from about 96 wt % to about 99 wt %, from about 98 wt % to about 99 wt %, from about 92 wt % to about 98 wt %, or from about 94 wt % to about 96 wt %. In a further aspect, the plurality of the edible products are present in the composition in an amount of from about 93 wt % to about 97 wt %. In a still further aspect, the plurality of the edible products are present in the composition in an amount of about 90 wt %, about 91 wt %, about 92 wt %, about 93 wt %, about 94 wt %, about 95 wt %, about 96 wt %, about 97 wt %, about 98 wt %, or about 99 wt %. In yet a further aspect, the plurality of the edible products are present in the composition in an amount of about 95 wt %.

In various aspects, the oil is present in the composition in an amount of from about 0.50 wt % to about 10 wt %. Thus, in various aspects, the oil is present in the composition in an amount of from about 0.50 wt % to about 8 wt %, from about 0.50 wt % to about 6 wt %, from about 0.50 wt % to about 4 wt %, from about 0.50 wt % to about 2 wt %, from about 2 wt % to about 10 wt %, from about 4 wt % to about 10 wt %, from about 6 wt % to about 10 wt %, from about 8 wt % to about 10 wt %, from about 2 wt % to about 8 wt %, or from about 4 wt % to about 6 wt %. In a further aspect, the oil is present in the composition in an amount of from about 2.0 wt % to about 6.0 wt %. In a still further aspect, the oil is present in the composition in an amount of about 0.5 wt %, about 1.0 wt %, about 2.0 wt %, about 3.0 wt %, about 4.0 wt %, about 5.0 wt %, about 6.0 wt %, about 7.0 wt %, about 8.0 wt %, about 9.0 wt %, or about 10 wt %. In yet a further aspect, the oil is present in the composition in an amount of about 4.0 wt %.

In various aspects, the herb powder is present in the composition in an amount of from about 0.40 wt % to about 1.4 wt %. Thus, in various aspects, the herb powder is present in the composition in an amount of from about 0.40 wt % to about 1.2 wt %, from about 0.40 wt % to about 1.0 wt %, from about 0.40 wt % to about 0.80 wt %, from about 0.40 wt % to about 0.60 wt %, from about 0.60 wt % to about 1.4 wt %, from about 0.80 wt % to about 1.4 wt %, from about 1.0 wt % to about 1.4 wt %, from about 1.2 wt % to about 1.4 wt %, from about 0.60 wt % to about 1.2 wt %, or from about 0.80 wt % to about 1.0 wt %. In a further aspect, the herb powder is present in the composition in an amount of from about 0.60 wt % to about 1.0 wt %. In a still further aspect, the herb powder is present in the composition in an amount of about 0.40 wt %, about 0.60 wt %, about 0.80 wt %, about 1.0 wt %, about 1.2 wt %, or about 1.4 wt %. In yet a further aspect, the herb powder is present in the composition in an amount of about 0.80 wt %.

In various aspects, the oil and the herb powder are present in the composition in a ratio of from about 3:2 to about 7:2. Thus, in various further aspects, the oil and the herb powder are present in the composition in a ratio of from about 3:2 to about 3:1, from about 3:2 to about 5:2, from about 3:2 to about 1:2, from about 1:2 to about 7:2, from about 5:2 to about 7:2, from about 3:1 to about 7:2, or from about 1:2 to about 3:1. In a still further aspect, the oil and the herb powder are present in the composition in a ratio of about 3:2, about 3:1, about 5:2, about 1:2, or about 7:2. In a yet further aspect, the oil and the herb powder are present in the composition in a ratio of about 5:2.

In various aspects, the plurality of the edible products are present in the composition in an amount of from about 90 wt % to about 99 wt %, wherein the oil is present in the composition in an amount of from about 0.5 wt % to about 10 wt %, wherein the herb powder is present in the composition in an amount of from about 0.40 wt % to about 1.4 wt %, and wherein the oil and the herb powder are present in the composition in a ratio of from about 3:2 to about 7:2. In a further aspect, the dehydrated food product is a freeze-dried food product, the oil is an edible oil selected from avocado oil, coconut oil, safflower oil, olive oil, sunflower oil, flax oil, palm oil, soybean oil, canola oil, corn oil, and peanut oil, or a mixture thereof, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In a still further aspect, the dehydrated food product is a freeze-dried aggregate fruit, the oil is coconut oil, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In yet a further aspect, the freeze-dried aggregate fruit is a freeze-dried blackberry. In an even further aspect, the herb powder is a sage powder.

In various aspects, the plurality of the edible products are present in the composition in an amount of from about 93 wt % to about 97 wt %, wherein the oil is present in the composition in an amount of from about 2.0 wt % to about 6.0 wt %, wherein the herb powder is present in the composition in an amount of from about 0.60 wt % to about 1.0 wt %, and wherein the oil and the herb powder are present in the composition in a ratio of from about 3:2 to about 7:2. In a further aspect, the dehydrated food product is a freeze-dried food product, the oil is an edible oil selected from avocado oil, coconut oil, safflower oil, olive oil, sunflower oil, flax oil, palm oil, soybean oil, canola oil, corn oil, and peanut oil, or a mixture thereof, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In a still further aspect, the dehydrated food product is a freeze-dried aggregate fruit, the oil is coconut oil, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In yet a further aspect, the freeze-dried aggregate fruit is a freeze-dried blackberry. In an even further aspect, the herb powder is a sage powder.

In various aspects, the plurality of the edible products are present in the composition in an amount of about 95 wt %, wherein the oil is present in the composition in an amount of about 4.0 wt %, wherein the herb powder is present in the composition in an amount of about 0.80 wt %, and wherein the oil and the herb powder are present in the composition in a ratio of about 5:2. In a further aspect, the dehydrated food product is a freeze-dried food product, the oil is an edible oil selected from avocado oil, coconut oil, safflower oil, olive oil, sunflower oil, flax oil, palm oil, soybean oil, canola oil, corn oil, and peanut oil, or a mixture thereof, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In a still further aspect, the dehydrated food product is a freeze-dried aggregate fruit, the oil is coconut oil, and the herb powder is selected from a dill powder, a sage powder, a thyme powder, a basil powder, a cinnamon powder, a paprika powder, a garlic powder, an onion powder, a rosemary powder, a pumpkin spice powder, a marijuana powder, and an apple pie spice powder, or a mixture thereof. In yet a further aspect, the freeze-dried aggregate fruit is a freeze-dried blackberry. In an even further aspect, the herb powder is a sage powder.

In various aspects, each edible product comprises a dehydrated aggregate fruit, and wherein dehydrated aggregate fruit is a freeze-dried berry.

### 1. Properties

As detailed further herein, the disclosed compositions can have various properties, including minimal clumping and excellent particle distribution (e.g., at least 90% whole berries or large pieces of berry and less than 10% broken berries, drupelets, and fines). It is also understood that the disclosed compositions have other properties.

The term “clumping,” as used herein, means groups or clusters of 2-3 berries stuck together. Clumping can be determined by, for example, conducting a visual assessment of a sample. As detailed herein, the disclosed composition beneficially exhibits minimal clumping, allowing for each berry to be individually coated with a substantially uniform layer of oil and herb powder. Thus, in various further aspects, the disclosed composition exhibits less clumping a comparative compositions prepared by a different method than those disclosed herein. In various further aspects, a disclosed composition exhibits at least 1% less clumping, at least 2% less clumping, at least 4% less clumping, at least 6% less clumping, at least 8% less clumping, at least 10% less clumping, at least 15% less clumping, at least 20% less clumping, or at least 25% less clumping than a comparative composition prepared by a different method than those disclosed herein.

The term “particle distribution,” as used herein, means the percentage of particles (e.g., an edible product as disclosed herein) having a certain size. Methods of determined particle distribution are well known in the art and include, but are not limited to, laser diffraction (LD), dynamic light scattering (DLS), dynamic image analysis (DIA), and sieve analysis. The particle distribution can be expressed as a “DXX,” wherein the “XX” indicates the percentage of particles (e.g., edible products as disclosed herein) that have a certain size or fall within a certain size range. For example, a D50 of 2 microns indicates that 50% of the particles are 2 microns or greater. Thus, in various aspects, the disclosed compositions have a D85 of 4.0 mm or greater (i.e., 85% of the edible products in the composition have a size of 4.0 mm or greater), indicating that 85% of the edible products in the composition are whole (e.g., whole berries). In various further aspects, the disclosed compositions have a D90 of 1.7 mm or greater, indicating that 90% of the edible products in the composition are whole or in large pieces (e.g., whole berries or large pieces of berries). In various further aspects, the disclosed compositions have a D5 of 0.85 mm or less (i.e., 5% of the edible products in the composition have a size of 0.85 mm or smaller). In various further aspects, less than 5% of the edible products in the composition have a size of 0.85 mm or smaller, indicating that less than 5% of the edible products are broken, drupelets, or fines.

In various aspects, the disclosed composition has a D85 that is greater than that of a comparative composition prepared by a different method than those disclosed herein. Thus, in various further aspects, the disclosed composition has a D90 that is greater than that of a comparative composition prepared by a different method than those disclosed herein.

### E. Beverages

In one aspect, disclosed are beverages comprising the disclosed edible products and/or the disclosed compositions. As used herein, the term “beverage” means a liquid good or product that is intended for consumption by, for example, a human. Examples of beverages include, but are not limited to, coffees (e.g., espressos, cappuccinos, Americanos, mochas, macchiatos, cold brews, iced coffee, black coffee), teas (e.g., chamomile, black tea, herbal tea, iced tea, flavored tea, Earl Grey tea, jasmine tea), sodas, juices, waters (e.g., fruit-flavored waters, sparkling waters, still waters, tonic waters), smoothies, wine, alcoholic cocktails, spritzers, and ciders. The term beverage, as used herein, includes both alcoholic and non-alcoholic beverages.

In various aspects, the beverage is a hot beverage. In various further aspects, the beverage is a cold beverage.

In various aspects, the beverage is a coffee or a tea.

In various aspects, the beverage is a water such as, for example, a fruit-flavored water, a still water, or a sparkling water.

In various aspects, and as discussed further herein, a disclosed edible product or a composition comprising a plurality of edible products can be added directly to the beverage. The edible product(s) can be further mashed, ground, or otherwise pulverized and stirred into the beverage, in order to endow the beverage with a savory, herbaceous flavor throughout. Alternatively, the edible product can be left in the beverage whole.

In various aspects, the beverage does not contain an herb flavorant. Examples of herb flavorants include, but are not limited to, a dill flavorant, a sage flavorant, a thyme flavorant, a basil flavorant, a cinnamon flavorant, a paprika flavorant, a garlic flavorant, an onion flavorant, a rosemary flavorant, a pumpkin spice flavorant, a marijuana flavorant, an apple pie spice flavorant, and a chili flavorant, or a mixture thereof. As detailed herein, the addition of an herb flavorant can endow the beverage with an offsetting and/or artificial taste. By combining the true herb (as an herb powder) and the dehydrated food product into a single edible product, the need to add a separate herb flavorant is beneficially avoided. Thus, while an herb flavorant can yet be added to the beverage, when desired, it's addition is no longer necessary.

### F. Kits

In one aspect, disclosed are kits comprising a disclosed edible product or a disclosed composition, and one or more selected from: (a) a food; (b) a beverage or beverage component; (c) instructions for preparing a food or a beverage or beverage component; and (d) instructions for adding an edible product to a food or a beverage or beverage component.

In various aspects, the kit comprises a food. In a further aspect, the food is a yogurt, a granola, a parfait, a cereal, an oatmeal, a soup, or a salad.

In various aspects, the kit comprises a beverage or a beverage component.

In various aspects, the kit comprises a beverage. In a further aspect, the beverage is a coffee, a tea, a fruit juice, a smoothie, a fruit-flavored water, a still water, or a sparkling water.

In various aspects, the kit comprises a beverage component. As used herein, the term “beverage component” refers to an edible ingredient that is used to prepare a beverage or otherwise combined with other edible ingredients to form a beverage. Examples of beverage components include, but are not limited to, a creamer, a cocktail mix, a lemonade drink mix, and a tea drink mix. In a further aspect, the beverage component is a drink mix such as, for example, a lemonade drink mix or a tea drink mix.

It is understood that the disclosed kits can be prepared from the disclosed edible products, compositions, and beverages. It is also understood that the disclosed kits can be employed in connection with the disclosed methods of using.

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

### G. Examples

The following examples are put forth so as to provide those of ordinary skill in the art with a complete disclosure and description of how the edible products, compositions, beverages, and kits claimed herein are made and evaluated. These examples are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

### 1. Manufacture of a Freeze-Dried, Herb-Coated Berry

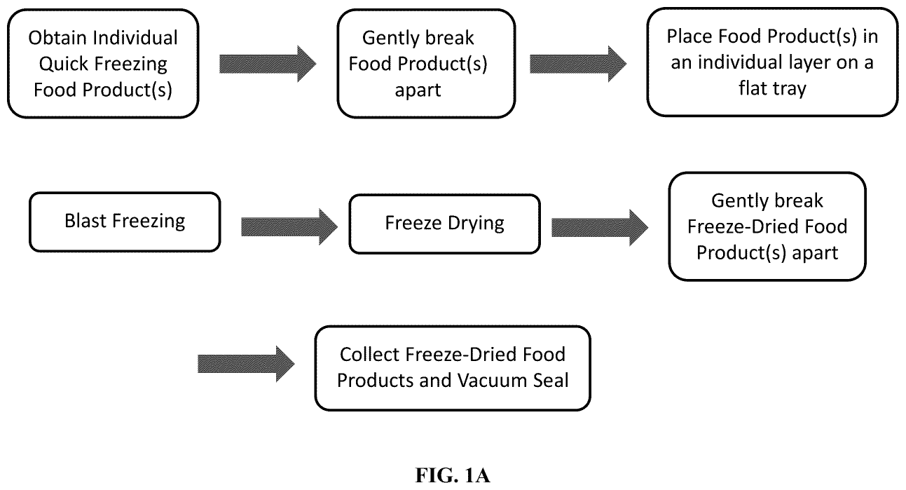

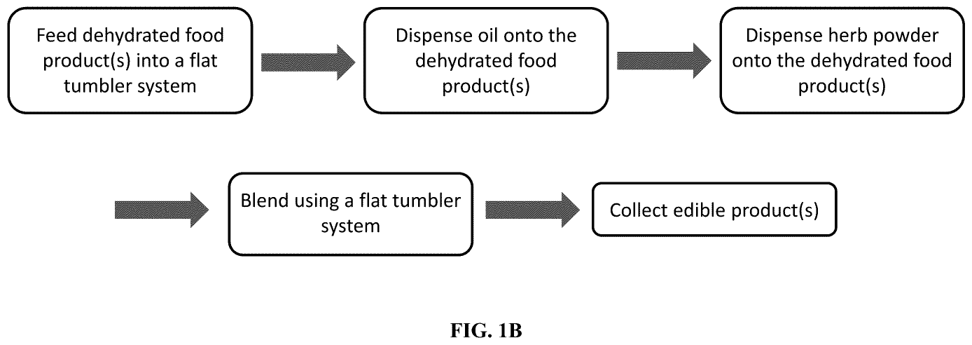

Freeze Drying Process. Individual quick freezing (IQF) whole blackberries (evergreen variety; originating from the United States, Chile, Mexico, or Serbia) were obtained and evaluated as compared to the raw material specification. The IQF berries were also inspected for larva as compared to the Food and Drug Administration (FDA) Food Defect Action levels (FDL). The IQF berries kept in freezer storage until ready for use (shelf life of IQF blackberries=2 years), at which time they were gently broken apart to minimize sticking and placed in an individual layer on a flat, sheet tray. Next, the IQF berries were subjected to blast freezing and then freeze-dried. The freeze-dried berries were then broken apart once more and vacuum sealed to minimize moisture until further processing (shelf-life of sealed, freeze-dried berries=approximately 6 months at ambient temperature). See FIG. 1A. Freeze-dried berries were evaluated for moisture, water activity, organoleptic, and density, and were also inspected for larva.

Blending/Mixing Process. The freeze-dried berries were fed into a flat tumbler system (capacity=300 lbs/hour) with gentle handling plates and a specific feed rate. Next, the freeze-dried berries were sprayed with coconut oil (coconut oil shelf life=approximately 3 years). Sage powder (originating from India; shelf life=approximately 2 years) was then dispensed directly onto the berries. See FIG. 1B. A summary of the materials and the amounts thereof is shown in Table 1 below.

TABLE 1

| Ingredient | Amount (%) |
|---|---|
| Blackberry | 95.2 |
| Coconut oil | 4.0 |
| Sage powder | 0.80 |
| Total | 100 |

The mixture (freeze-dried berries, oil, and herb powder) was subjected to sieve analysis at the beginning, middle, and end of the process. The coated berries were then placed into pouches and vacuum-sealed (shelf life of sealed, coated berries=approximately 6-9 months; shelf life of the coated berries once opened=approximately 5 days).

### 2. Properties of Freeze-Dried, Herb-Coated Berries

The properties of the in-process product and the finished product are detailed in Table 2 and Table 3, respectively.

TABLE 2

| Test | Target / Range |
|---|---|
| Brix IQF | ≥9.5 |
| Moisture | <4% |
| Particle distribution | N/A |
| Color | Blackberry: 7419-7421U; |
| | Sage: 383U-399U |

TABLE 3

| Test | Target | Range | Should Not Be |
|---|---|---|---|
| Brix | N/A | N/A | N/A |
| Moisture | <4% | <4% | N/A |
| Water Activity | <0.3 | <0.3 | Outside of range |
| Particle distribution | | USS # 5, | |
| | | 12, and 20 | |
| Collected on a #5 Sieve | 86% | More than 85% | Less than 85% |
| (whole berries) | | | |
| Collected on a #12 Sieve | Less than 6% | Less than 7% | More than 7% |
| (Small blackberries and | | | |
| large pieces) | | | |
| Combined total on both #5 | 92% | 90-100% | Less than 90% |
| and #12 Sieve (whole | | | |
| berries, small blackberries, | | | |
| large pieces) | | | |
| On or passing through a | Less than 5% | 3-7% | More than 7% |
| #20 pan (broken berries, | | | |
| drupelets, and fines) | | | |
| Clumping 2-3 or more | 1 clump of | 1-2 clumps | More than 2 |
| berries stuck together | 2-3 berries | | clumps |
| Color | | Blackberry: | Discoloring that is |
| | | 7419-7421U; | outside of range. |
| | | Sage: | |
| | | 383U-399U | |
| Appearance | Individual, | N/A | Excessive fines, |
| | whole | | clumping, or |
| | blackberries | | broken pieces as |
| | that are coated | | defined in |
| | in sage. | | protocol. |

A summary of the acceptable microbiological properties, and the methods used to assess these properties, is provided in Table 4.

TABLE 4

| Property | Limit | Method |
|---|---|---|
| Total Viable Count or | <100,000 cfu/g | AOAC OMA 990.12 |
| Aerobic Plate count | maximum | |
| Yeast and Mold | <5000 cfu/g maximum | AOAC OMA 2014.05 |
| Salmonella | Absent / 375 g | AOAC RI010803 |
| | (15 × 25 g | |
| | composite sample) | |
| Enterobacteriaceae (EB) | <500 cfu/g | AOAC OMA 2003.01 |

Importantly, the final product should exhibit a water activity (aw) value of less than 0.4. The final product should also be free from foreign materials. Upon being subject to a sensory evaluation, the flavor should be that of ripe, sweet blackberries with a subtle, earthy, note of dried sage (lightly coated with sage and crunchy in texture). The product should not give off any off-flavor notes such as a sour, bitter, or rancid taste. It should also not be overly brittle in texture, mushy, or soft.

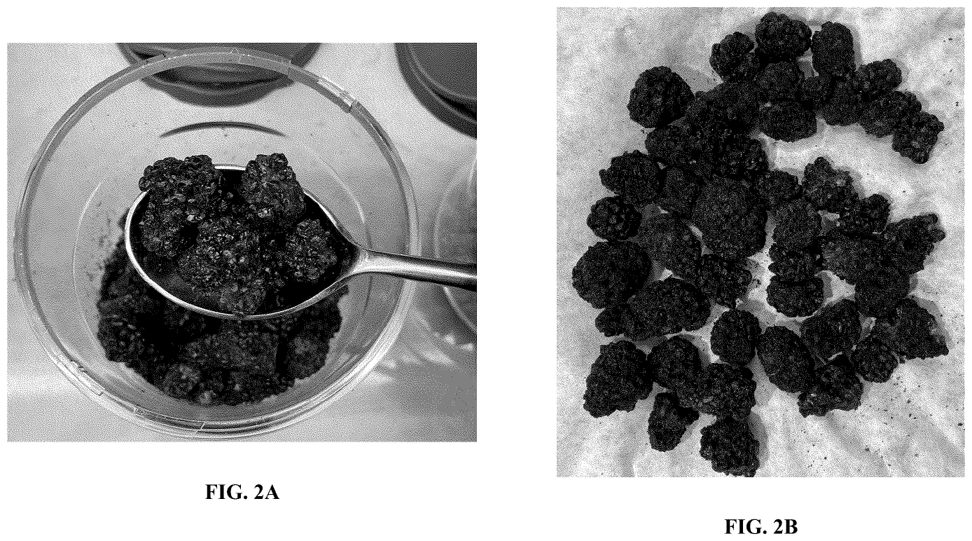

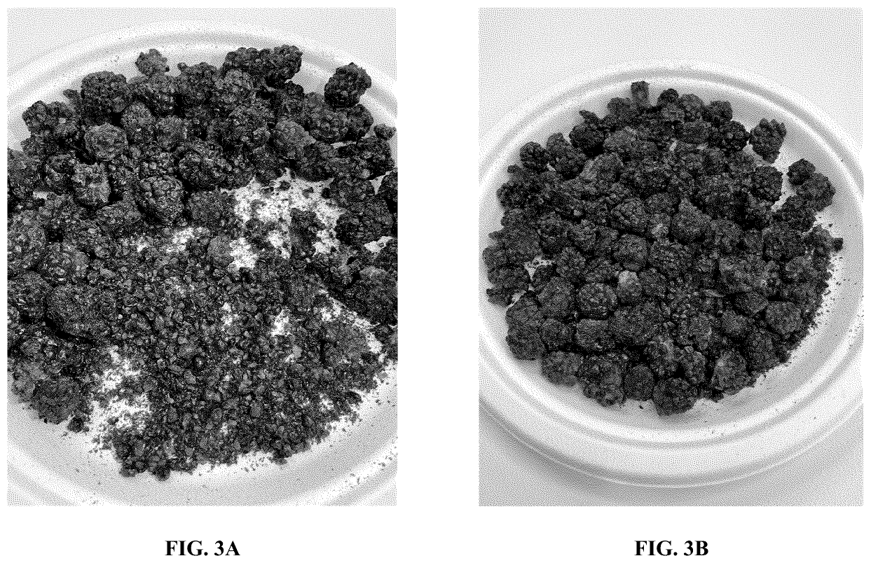

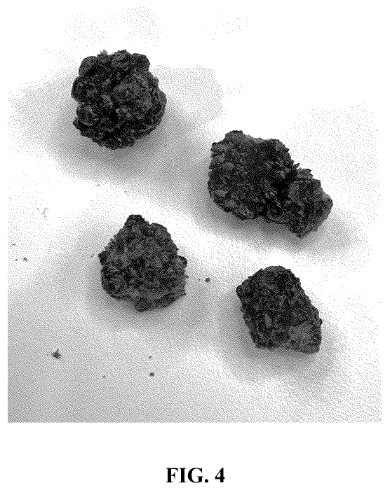

Images of the target finished product are shown in FIG. 2A and FIG. 2B. Comparative finished products prepared by alternative methods are shown in FIG. 3A, FIG. 3B, and FIG. 4. As shown, these comparative products have a large number of berry drupelets broken off and exhibit significant corn cobbing, which together result in an exposed berry interior.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An edible product comprising a dehydrated food product, at least a portion of which is coated with a mixture comprising an oil and an herb powder.

2. The edible product of claim 1, wherein the dehydrated food product is a freeze-dried fruit.

3. The edible product of claim 1, wherein the dehydrated food product is a dehydrated aggregate fruit.

4. The edible product of claim 1, wherein the dehydrated fruit is coated relatively uniformly with the mixture.

5. The edible product of claim 1, wherein the oil is selected from avocado oil, coconut oil, safflower oil, olive oil, sunflower oil, flax oil, palm oil, soybean oil, canola oil, corn oil, and peanut oil, or a mixture thereof.

6. The edible product of claim 1, wherein the herb powder is selected from a dill powder, a sage powder, a thyme powder, a basil powder, a cinnamon powder, a paprika powder, a garlic powder, an onion powder, a rosemary powder, a pumpkin spice powder, an apple pie spice powder, a marijuana powder, and a chili powder, or a mixture thereof.

7. The edible product of claim 1, wherein the oil and the herb powder are present in the edible product in a ratio of from about 3:2 to about 7:2.

8. The edible product of claim 1, wherein the oil and the herb powder are present in the edible product in a ratio of about 5:2.

9. A composition comprising a plurality of the edible products of claim 1.

10. The composition of claim 9, wherein the plurality of the edible products are present in the composition in an amount of from about 90 wt % to about 99 wt %.

11. The composition of claim 9, wherein the oil is present in the composition in an amount of from about 0.50 wt % to about 10 wt %.

12. The composition of claim 9, wherein the herb powder is present in the composition in an amount of from about 0.40 wt % to about 1.4 wt %.

13. The composition of claim 9, wherein the plurality of the edible products are present in the composition in an amount of from about 93 wt % to about 97 wt %, wherein the oil is present in the composition in an amount of from about 2.0 wt % to about 6.0 wt %, wherein the herb powder is present in the composition in an amount of from about 0.60 wt % to about 1.0 wt %, and wherein the oil and the herb powder are present in the composition in a ratio of from about 3:2 to about 7:2.

14. The composition of claim 13, wherein each edible product comprises a dehydrated fruit, and wherein the dehydrated fruit is a freeze-dried aggregate fruit.

15. A beverage comprising the edible product of claim 1.

16. A kit comprising the edible product of claim 1, and one or more selected from:
(a) a food;
(b) a beverage or beverage component;
(c) instructions for preparing a food or a beverage; and
(d) instructions for adding an edible product to a food or a beverage or beverage product.

17. The kit of claim 16, wherein the food is a yogurt, a granola, a parfait, a cereal, an oatmeal, a soup, or a salad.

18. The kit of claim 16, wherein the beverage component is a drink mix.

19. A method of making the edible product of claim 1, the method comprising:
(a) providing a dehydrated food product;
(b) dispensing an oil onto the dehydrated food product;
(c) dispensing an herb powder onto the dehydrated food product; and
(d) blending the oil, the herb powder, and the dehydrated food product using a flat tumbler system.

20. The method of claim 19, wherein the dehydrated food product is a freeze-dried aggregate fruit, and wherein providing the dehydrated food product comprises:
(a) providing a plurality of quick frozen aggregate fruits;
(b) breaking the plurality of quick frozen aggregate fruits apart and laying the quick frozen aggregate fruits flat on a tray in an individual layer;
(c) blast freezing the individual layer of quick frozen aggregate fruits; and
(d) freeze drying the individual layer of quick frozen aggregate fruits, thereby providing a plurality of freeze-dried aggregate fruits.
